(19) United States
(12) Patent Application Publication
(10) Pub. No.: US 2022/0081573 A1
(43) Pub. Date: Mar. 17, 2022

(54) SELECTIVE ANTI-TARNISH COATING

(71) Applicant: Nano and Advanced Materials Institute Limited, Hong Kong (CN)

(72) Inventors: King Ho SO, Hong Kong (CN); Lok Hang KEUNG, Hong Kong (CN); Ka Kit YEE, Hong Kong (CN); Ka Chun LEE, Hong Kong (CN)

(21) Appl. No.: 17/444,839

(22) Filed: Aug. 11, 2021

Related U.S. Application Data
(60) Provisional application No. 62/706,885, filed on Sep. 16, 2020.

(51) Int. Cl. C09D 5/08; C09D 5/44; C09D 175/14; C09D 7/45; C09D 7/65; C09D 7/41; C25D 9/02; C25D 5/50

(52) U.S. Cl. CPC C09D 5/08; C09D 5/4492; C09D 5/4496; C09D 175/14; C25D 5/505; C09D 7/65; C09D 7/41; C25D 9/02; C09D 7/45

(57) ABSTRACT

An anti-tarnish composition including a polymer resin; a photoinitiator; a coating thickness adjusting agent; and optionally a dye useful for protecting metal substrates from tarnishing and methods of applying the anti-tarnish composition to metal substrates using an electroplating method. The anti-tarnish composition can be selectively applied to the metal surfaces of jewelry containing gemstones.

### CROSS-REFERENCE TO RELATED APPLICATIONS

This application claims priority from U.S. Provisional Patent Application No. 62/706,885 filed on Sep. 16, 2020, the content of which is hereby incorporated by reference in its entirety.

### TECHNICAL FIELD

The present disclosure generally relates to compositions useful as anti-tarnish coatings for metal substrates, such as jewelry. More particularly, provided herein is an anti-tarnish composition and methods of use and preparation thereof.

### BACKGROUND

Metal jewelry of various colors has generated a great deal of consumer interest in recent years. Rose gold is one such colored variant of gold. The pinkish hue of rose gold results by the incorporation of copper in the gold. However, such copper-containing gold is known to quickly tarnish upon exposure to air through oxidative processes. A number of anti-tarnish coatings have been developed that inhibit tarnishing, such as by application of a protective organic coating or atomic layer deposition (ALD) of the metal substrate surface. Although organic coating protection can provide a simple and cost effective means for protecting a metal substrate from tarnishing, in many cases, the protection is not sufficient when applied on copper containing gold. ALD, on the other hand, delivers better anti-tarnish protection, but at high cost and complicated processing. Also, these surface protection methods may be not sufficiently selective when applied on jewelry that contains a stone, such as a diamond or other gemstone, such that the diamond or other gemstone will also be covered with the coating hence affecting its surface appearance to some extent.

There thus exists a need for improved methods and compositions for applying an anti-tarnish coating to a metal substrate, particularly a colored metal substrate, such as rose gold, which address or overcomes at least some of the issues raised above.

### SUMMARY

The present disclosure provides a selective anti-tarnish coating useful for coating a metal substrate, such as silver and gold jewelry, and methods of use and preparation thereof. The anti-tarnish coatings described herein can be selectively applied on the metal part of a substrate, such as a jewelry for protection, while any gemstone or diamond that may be present on the jewelry can remain uncoated. In addition, the anti-tarnish coating can optionally comprise colored dyes, hence the resultant jewelry can be colored by the coating.

In a first aspect, provided herein is an anti-tarnish composition comprising: a polymer resin comprising: at least one diluent monomer selected from the group consisting of an alkyl acrylate and an alkyl methacrylate; at least one catonizable monomer selected from the group consisting of a catonizable acrylate monomer and a catonizable methacrylate monomer, wherein at least a portion of the at least one catonizable monomer is in cationic form; at least one polarizable monomer selected from the group consisting of a hydroxyl containing acrylate monomer and a hydroxyl containing methacrylate monomer; and an aryl olefin monomer, wherein the polymer resin is optionally crosslinked; a photoinitiator; a coating thickness adjusting agent; and optionally a dye.

In a first embodiment of the first aspect, provided herein is the anti-tarnish composition of the first aspect, wherein the at least one catonizable monomer comprises a cationizable group selected from the group consisting of a primary ammonium, secondary ammonium, tertiary ammonium, a quaternary ammonium and a pyrridinium.

In a second embodiment of the first aspect, provided herein is the anti-tarnish composition of the first aspect, wherein the at least one catonizable monomer is represented by the Formula 1:

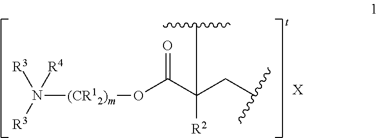

wherein

X is an anion or is absent;

t is +1 or 0;

m is a whole number selected from 2-10;

R¹ for each occurrence is independently hydrogen, alkyl, cycloalkyl, or aryl; or two instances of R¹ taken together with the carbon or carbons to which they are attached form a 3-7 membered cycloalkyl;

R² is hydrogen or methyl;

R³ for each occurrence is independently hydrogen, alkyl, alkenyl, alkynyl, cycloalkyl, aryl, aralkyl, heteroaryl, or heteroaralkyl; or two instances of R³ taken together with the nitrogen to which they are attached form a 3-7 membered heterocycloalkyl or 5 membered heteroaryl; or one instance of R¹ and one instance of R³ taken together with the atoms to which they are attached form a 3-7 membered heterocycloalkyl; and

R⁴ is a lone pair, hydrogen, or alkyl, wherein if R⁴ is a lone pair then X is absent and t is 0.

In a third embodiment of the first aspect, provided herein is the anti-tarnish composition of the second embodiment of the first aspect, wherein X is Cl⁻, Br⁻, I⁻, NO₃⁻, PO₄³⁻, HPO₄²⁻, H₂PO₄⁻, SO₄²⁻, HSO₄⁻, CH₃CO₂⁻, HCO₂⁻, lactate, tartrate, citrate, propionate, oxalate, malate, succinate, benzoate, methylsulfonate, or phenylsulfonate.

In a fourth embodiment of the first aspect, provided herein is the anti-tarnish composition of the first aspect, wherein the at least one cationizable monomer is selected from the group consisting of 2-(dimethylamino)ethyl methacrylate, 2-(dimethylamino)ethyl acrylate, a 2-dii sopropylaminoethyl methacrylate, and 2-diisopropylaminoethyl acrylate.

In a fifth embodiment of the first aspect, provided herein is the anti-tarnish composition of the first aspect, wherein the at least one polarizable monomer is represented by the Formula 2:

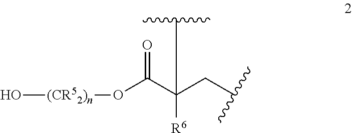

wherein

n is a whole number selected from 2-10;

R⁵ for each occurrence is independently hydrogen, alkyl, cycloalkyl, or aryl; or two instances of R⁵ taken together with the carbon or carbons to which they are attached form a 3-7 membered cycloalkyl; and

R⁶ is hydrogen or methyl.

In a sixth embodiment of the first aspect, provided herein is the anti-tarnish composition of the first aspect, wherein the at least one polarizable monomer is selected from the group consisting of 2-hydroxypropyl acrylate, 2-hydroxyethyl methacrylate, 4-hydroxybutyl acrylate, 4-hydroxybutyl methacrylate, 3-phenoxy-2-hydroxypropyl acrylate, 3-phenoxy-2-hydroxypropyl methacrylate, 2-hydroxyethyl acrylate, and 2-hydroxyethyl methacrylate.

In a seventh embodiment of the first aspect, provided herein is the anti-tarnish composition of the first aspect, wherein the aryl olefin monomer is an optionally substituted phenylethylene monomer.

In an eighth embodiment of the first aspect, provided herein is the anti-tarnish composition of the first aspect, wherein the polymer resin is crosslinked with a diisocyanate or a polyisocyanate.

In a ninth embodiment of the first aspect, provided herein is the anti-tarnish composition of the first aspect, wherein the polymer resin is crosslinked with isophorone diisocyanate or 4,4′-methylenebis(cyclohexyl isocyanate).

In a tenth embodiment of the first aspect, provided herein is the anti-tarnish composition of the first aspect, wherein the photoinitiator is an acylphosphine oxide.

In an eleventh embodiment of the first aspect, provided herein is the anti-tarnish composition of the first aspect, wherein the photoinitiator is bis(2,4,6-trimethyl benzoyl)phenyl phosphine oxide (BAPO) or 2,4,6-trimethylbenzoyl diphenyl phosphine (TPO).

In a twelfth embodiment of the first aspect, provided herein is the anti-tarnish composition of the first aspect, wherein the coating thickness adjusting agent is a non-ionic surfactant.

In a thirteenth embodiment of the first aspect, provided herein is the anti-tarnish composition of the first aspect, wherein the coating thickness adjusting agent is t-octylphenoxypolyethoxyethanol or polyethylene glycol sorbitan monolaurate.

In a fourteenth embodiment of the first aspect, provided herein is the anti-tarnish composition of the first aspect, wherein the dye is selected from the group consisting of polyacrylic acid based dyes.

In a fifteenth embodiment of the first aspect, provided herein is the anti-tarnish composition of the first aspect, wherein the dye has an average particle size between 50 to 250 nm.

In a sixteenth embodiment of the first aspect, provided herein is the anti-tarnish composition of the first aspect, wherein the anti-tarnish composition comprises: a polymer resin comprising: at least one diluent monomer selected from the group consisting of C₁-C₈ alkyl acrylate and C₁-C₈ alkyl methacrylate; at least one catonizable monomer represented by the Formula 1:

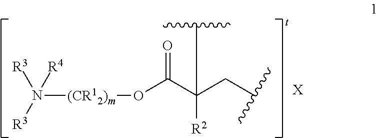

wherein

X is an anion or absent;

t is +1 or 0;

m is a whole number selected from 2-4;

R¹ for each occurrence is hydrogen or alkyl;

R² is hydrogen or methyl;

R³ for each occurrence is independently hydrogen or alkyl; or two instances of R³ taken together with the nitrogen to which they are attached form a 3-6 membered heterocycloalkyl; and

R⁴ is a lone pair or hydrogen, wherein if R⁴ is a lone pair then X is absent and t is 0;

at least one polarizable monomer represented by the Formula 2:

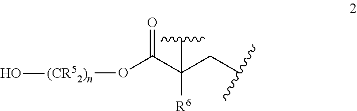

wherein

n is a whole number selected from 2-4;

R⁵ for each occurrence is hydrogen or alkyl; and

R⁶ is hydrogen or methyl;

an optionally substituted phenylethylene monomer; and

the polymer resin is crosslinked with a diisocyanate or a polyisocyanate;

an acylphosphine oxide;

a non-ionic surfactant; and

optionally a dye.

In a seventeenth embodiment of the first aspect, provided herein is the anti-tarnish composition of the sixteenth embodiment of the first aspect, wherein the polymer resin, the non-ionic surfactant, and the acylphosphine oxide are present at 79% to 94% by weight, 4% to 17% by weight, and 2% to 4% by weight respectively with respect to the combined weight of the polymer resin, the non-ionic surfactant, and the acylphosphine oxide.

In an eighteenth embodiment of the first aspect, provided herein is the anti-tarnish composition of the seventeenth embodiment of the first aspect further comprising up to 6% by weight of the dye.

In a nineteenth embodiment of the first aspect, provided herein is the anti-tarnish composition of the first aspect, wherein the anti-tarnish composition comprises: a polymer resin comprising: butyl acrylate monomer, methyl methacrylate monomer; 2-(dimethylamino)ethyl methacrylate monomer, wherein at least a portion of the 2-(dimethylamino)ethyl methacrylate monomer exists as a conjugate lactate salt; and 2-hydroxyethyl methacrylate monomer, wherein the polymer resin is crosslinked with isophorone diisocyanate;

t-octylphenoxypolyethoxyethanol;

TPO; and

optionally a dye,

wherein the polymer resin, t-octylphenoxypolyethoxyethanol, TPO, and the dye are present relative to their combined weight at 79% to 94% by weight, 4% to 17% by weight, 2% to 4% by weigh, and 0% to 6% by weight, respectively.

In a second aspect, provided herein is a method for applying the anti-tarnish composition of the first aspect to a metal substrate, the method comprising:

providing an cathode comprising the metal substrate;

an anode; and

an electrolyte solution comprising the anti-tarnish composition in contact with the cathode and the anode; and

applying an electric current between the cathode and the anode resulting in the electrochemical deposition of the anti-tarnish composition on at least one surface of the metal substrate thereby forming an anti-tarnish coated metal substrate.

In a first embodiment of the second aspect, provided herein is the method of the of the second aspect further comprising the step of heating the anti-tarnish coated metal substrate at a temperature between 50-120° C. thereby forming a thermally treated anti-tarnish coated metal substrate.

In a second embodiment of the second aspect, provided herein is the method of the second aspect further comprising the step of irradiating the anti-tarnish coated metal substrate with UV light.

In a third embodiment of the second aspect, provided herein is the method of the first embodiment of the second aspect further comprising the step of irradiating the thermally treated anti-tarnish coated metal substrate with UV light.

Other aspects and advantages of the present invention will be apparent to those skilled in the art from a review of the ensuing description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other objects and features of the present invention will become apparent from the following description of the invention, when taken in conjunction with the accompanying drawings, in which:

FIG. 1 depicts an exemplary process for preparing the polymer resin according to certain embodiments described herein.

FIG. 2 depicts an exemplary process for depositing the anti-tarnish composition on a jewelry substrate according to certain embodiments described herein.

FIG. 3 depicts K₂S accelerated corrosion test results of a rose gold ring with and without an anti-tarnish composition costing as described herein

FIG. 4 depicts rings with a gemstone that have been coated with the anti-tarnish composition containing different concentrations of blue dye in accordance with certain embodiments described herein.

FIG. 5 depicts experimental data showing the effect of the concentration of the non-ionic surfactant t-octylphenoxypolyethoxyethanol sold under the trademark Triton™ X-100 on the thickness of the applied coating of the anti-tarnish composition according to certain embodiments described herein.

FIG. 6A depicts a table detailing reaction stoichiometry for the first step of preparing the polymer resin in which the amount of azobisisobutyronitrile (AIBN) is varied.

FIG. 6B shows photographs of the effect of varying the amount of AIBN used on the appearance of rings that were coated with the anti-tarnish compositions described in FIG. 6A.

FIG. 7 depicts photographs showing the effect of varying the amount of the non-ionic surfactant t-octylphenoxypolyethoxyethanol sold under the trademark Triton™ X-100 on the coating thickness of anti-tarnish compositions according to certain embodiments described herein.

FIG. 8 depicts an illustration of the effect of the presence of the non-ionic surfactant t-octylphenoxypolyethoxyethanol sold under the trademark Triton™ X-100 in the electrochemical deposition of the anti-tarnish composition on a jewelry substrate.

FIG. 9 depicts a table presenting experimental results showing the effect of the applied voltage on the electrochemical deposition of the anti-tarnish composition coating.

FIG. 10 depicts a photograph showing gold and silver jewelry coated with the anti-tarnish composition described herein.

FIG. 11 depicts photographs showing K₂S accelerated corrosion tests on silver and rose gold jewelry coated with the anti-tarnish composition described herein.

FIG. 12 depicts photographs of jewelry coated with the anti-tarnish composition described herein containing bluish green or black dye.

FIG. 13 depicts photographs showing K₂S accelerated corrosion tests on jewelry coated with the anti-tarnish composition comprising a bluish green dye as described herein.

FIG. 14 depicts photographs showing experiments demonstrating the selective application of the anti-tarnish composition described herein on the metal surfaces of jewelry containing a diamond.

FIG. 15 depicts photographs showing K₂S accelerated corrosion tests on rose gold jewelry coated with the anti-tarnish composition described herein, untreated rose gold, and rose gold treated with a commercially available anti-tarnish coating.

### DETAILED DESCRIPTION

The present disclosure provides an anti-tarnish composition comprising a polymer resin comprising: at least one diluent monomer selected from the group consisting of an alkyl acrylate and an alkyl methacrylate; at least one catonizable monomer selected from the group consisting of a catonizable acrylate monomer and a catonizable methacrylate monomer, wherein at least a portion of the at least one catonizable monomer is in cationic form; at least one polarizable monomer selected from the group consisting of a hydroxyl containing acrylate monomer and a hydroxyl containing methacrylate monomer; and an aryl olefin monomer, wherein the polymer resin is optionally crosslinked; a photoinitiator; a coating thickness adjusting agent; and optionally a dye.

### Definitions

The following terms shall be used to describe the present invention. In the absence of a specific definition set forth herein, the terms used to describe the present invention shall be given their common meaning as understood by those of ordinary skill in the art.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

As used herein, “alkyl” refers to a straight-chain or branched saturated hydrocarbon group. Examples of alkyl groups include methyl-, ethyl-, propyl (e.g., n-propyl and isopropyl), butyl (e.g., n-butyl, iso-butyl, sec-butyl, tert-butyl), pentyl groups (e.g., 1-methylbutyl, 2-methylbutyl, iso-pentyl, tert-pentyl, 1,2-dimethylpropyl, neopentyl, and 1-ethylpropyl), hexyl groups, and the like. In various embodiments, an alkyl group can have 1 to 40 carbon atoms (i.e., C1-40 alkyl group), for example, 1-30 carbon atoms (i.e., C1-30 alkyl group). In certain embodiments, an alkyl group can have 1 to 6 carbon atoms, and can be referred to as a “lower alkyl group.” Examples of lower alkyl groups include methyl, ethyl, propyl (e.g., n-propyl and isopropyl), and butyl groups (e.g., n-butyl, isobutyl, sec-butyl, tert-butyl). In certain embodiments, alkyl groups can be optionally substituted as described herein. An alkyl group is generally not substituted with another alkyl group, an alkenyl group, or an alkynyl group.

As used herein, “alkenyl” refers to a straight-chain or branched alkyl group having one or more carbon-carbon double bonds. Examples of alkenyl groups include ethenyl, propenyl, butenyl, pentenyl, hexenyl, butadienyl, pentadienyl, hexadienyl groups, and the like. The one or more carbon-carbon double bonds can be internal (such as in 2-butene) or terminal (such as in 1-butene). In various embodiments, an alkenyl group can have 2 to 40 carbon atoms (i.e., C2-40 alkenyl group), for example, 2 to 20 carbon atoms (i.e., C2-20 alkenyl group). In certain embodiments, alkenyl groups can be substituted as described herein. An alkenyl group is generally not substituted with another alkenyl group, an alkyl group, or an alkynyl group.

As used herein, “cycloalkyl” by itself or as part of another substituent means, unless otherwise stated, a monocyclic hydrocarbon having between 3-12 carbon atoms in the ring system and includes hydrogen, straight chain, branched chain, and/or cyclic substituents. Exemplary cycloalkyls include cyclopropyl, cyclobutyl, cyclopentyl, cyclohexyl, cycloheptyl, and the like.

As used herein, “heteroatom” refers to an atom of any element other than carbon or hydrogen and includes, for example, nitrogen, oxygen, silicon, sulfur, phosphorus, and selenium.

As used herein, “aryl” refers to an aromatic monocyclic hydrocarbon ring system or a polycyclic ring system in which two or more aromatic hydrocarbon rings are fused (i.e., having a bond in common with) together or at least one aromatic monocyclic hydrocarbon ring is fused to one or more cycloalkyl and/or cycloheteroalkyl rings. An aryl group can have 6 to 24 carbon atoms in its ring system (e.g., C6-24 aryl group), which can include multiple fused rings. In certain embodiments, a polycyclic aryl group can have 8 to 24 carbon atoms. Any suitable ring position of the aryl group can be covalently linked to the defined chemical structure. Examples of aryl groups having only aromatic carbocyclic ring(s) include phenyl, 1-naphthyl (bicyclic), 2-naphthyl (bicyclic), anthracenyl (tricyclic), phenanthrenyl (tricyclic), pentacenyl (pentacyclic), and like groups. Examples of polycyclic ring systems in which at least one aromatic carbocyclic ring is fused to one or more cycloalkyl and/or cycloheteroalkyl rings include, among others, benzo derivatives of cyclopentane (i.e., an indanyl group, which is a 5,6-bicyclic cycloalkyl/aromatic ring system), cyclohexane (i.e., a tetrahydronaphthyl group, which is a 6,6-bicyclic cycloalkyl/aromatic ring system), imidazoline (i.e., a benzimidazolinyl group, which is a 5,6-bicyclic cycloheteroalkyl/aromatic ring system), and pyran (i.e., a chromenyl group, which is a 6,6-bicyclic cycloheteroalkyl/aromatic ring system). Other examples of aryl groups include benzodioxanyl, benzodioxolyl, chromanyl, indolinyl groups, and the like. In certain embodiments, aryl groups can be optionally substituted. In certain embodiments, an aryl group can have one or more halogen substituents, and can be referred to as a “haloaryl” group. Perhaloaryl groups, i.e., aryl groups where all of the hydrogen atoms are replaced with halogen atoms (e.g., —C₆F₅), are included within the definition of “haloaryl.” In certain embodiments, an aryl group is substituted with another aryl group and can be referred to as a biaryl group. Each of the aryl groups in the biaryl group can be optionally substituted.

The term “aralkyl” refers to an alkyl group substituted with an aryl group.

As used herein, “heteroaryl” refers to an aromatic monocyclic ring system containing at least one ring heteroatom selected from oxygen (O), nitrogen (N), sulfur (S), silicon (Si), and selenium (Se) or a polycyclic ring system where at least one of the rings present in the ring system is aromatic and contains at least one ring heteroatom. Polycyclic heteroaryl groups include those having two or more heteroaryl rings fused together, as well as those having at least one monocyclic heteroaryl ring fused to one or more aromatic carbocyclic rings, non-aromatic carbocyclic rings, and/or non-aromatic cycloheteroalkyl rings. A heteroaryl group, as a whole, can have, for example, 5 to 24 ring atoms and contain 1-5 ring heteroatoms (i.e., 5-20 membered heteroaryl group). The heteroaryl group can be attached to the defined chemical structure at any heteroatom or carbon atom that results in a stable structure. Generally, heteroaryl rings do not contain O—O, S—S, or S—O bonds. However, one or more N or S atoms in a heteroaryl group can be oxidized (e.g., pyridine N-oxide thiophene S-oxide, thiophene S,S-dioxide). Examples of heteroaryl groups include, for example, the 5- or 6-membered monocyclic and 5-6 bicyclic ring systems shown below: where T is O, S, NH, N-alkyl, N-aryl, N-(arylalkyl) (e.g., N-benzyl), SiH₂, SiH(alkyl), Si(alkyl)₂, SiH(arylalkyl), Si(arylalkyl)₂, or Si(alkyl)(arylalkyl). Examples of such heteroaryl rings include pyrrolyl, furyl, thienyl, pyridyl, pyrimidyl, pyridazinyl, pyrazinyl, triazolyl, tetrazolyl, pyrazolyl, imidazolyl, isothiazolyl, thiazolyl, thiadiazolyl, isoxazolyl, oxazolyl, oxadiazolyl, indolyl, isoindolyl, benzofuryl, benzothienyl, quinolyl, 2-methylquinolyl, isoquinolyl, quinoxalyl, quinazolyl, benzotriazolyl, benzimidazolyl, benzothiazolyl, benzisothiazolyl, benzisoxazolyl, benzoxadiazolyl, benzoxazolyl, cinnolinyl, 1H-indazolyl, 2H-indazolyl, indolizinyl, isobenzofuyl, naphthyridinyl, phthalazinyl, pteridinyl, purinyl, oxazolopyridinyl, thiazolopyridinyl, imidazopyridinyl, furopyridinyl, thienopyridinyl, pyridopyrimidinyl, pyridopyrazinyl, pyridopyridazinyl, thienothiazolyl, thienoxazolyl, thienoimidazolyl groups, and the like. Further examples of heteroaryl groups include 4,5,6,7-tetrahydroindolyl, tetrahydroquinolinyl, benzothienopyridinyl, benzofuropyridinyl groups, and the like. In certain embodiments, heteroaryl groups can be substituted as described herein. In certain embodiments, heteroaryl groups can be optionally substituted.

The term “optionally substituted” refers to a chemical group, such as alkyl, cycloalkyl aryl, and the like, wherein one or more hydrogen may be replaced with a substituent as described herein, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like

The polymer resin may comprise at least one catonizable monomer. In certain embodiments, the polymer resin comprises 1, 2, 3, 4, or more catonizable monomers. In certain embodiments, the at least one catonizable monomer is represented by the Formula 1:

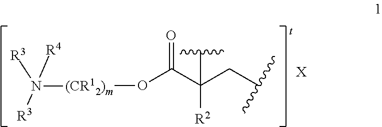

wherein X is an anion or is absent;

t is +1 or 0;

m is a whole number selected from 2-10;

R¹ for each occurrence is independently hydrogen, alkyl, cycloalkyl, or aryl; or two instances of R¹ taken together with the carbon or carbons to which they are attached form a 3-7 membered cycloalkyl;

R² is hydrogen or methyl;

R³ for each occurrence is independently hydrogen, alkyl, alkenyl, alkynyl, cycloalkyl, aryl, aralkyl, heteroaryl, or heteroaralkyl; or two instances of R³ taken together with the nitrogen to which they are attached form a 3-7 membered heterocycloalkyl or 5 membered heteroaryl; or one instance of R¹ and one instance of R³ taken together with the atoms to which they are attached form a 3-7 membered heterocycloalkyl; and

R⁴ is a lone pair, hydrogen, or alkyl, wherein if R⁴ is a lone pair then X is absent and t is 0.

As set out herein, the moiety of Formula 1 contains a cationizable group, such as amino, and are thus capable of existing in cationic form together with one or more anions. X can be any inorganic or organic anion known in the art. In certain embodiments, X is a relatively non-toxic anion. Exemplary anions include, but are not limited to a halide (e.g., chloride, bromide, and iodide) sulfate, phosphate, sulfamate, nitrate, acetate, trifluoroacetate, trichloroacetate, propionate, hexanoate, cyclopentylpropionate, glycolate, glutarate, pyruvate, lactate, malonate, succinate, sorbate, ascorbate, malate, maleate; fumarate, tartarate, citrate, benzoate, 3-(4-hydroxybenzoyl)benzoate, picrate, cinnamate, mandelate, phthalate, laurate, methanesulfonate (mesylate), ethanesulfonate, 1,2-ethane-disulfonate, 2-hydroxyethanesulfonate, benzenesulfonate (besylate), 4-chlorobenzenesulfonate, 2-naphthalenesulfonate, 4-toluenesulfonate, camphorate, camphorsulfonate, 4-methylbicyclo[2.2.2]-oct-2-ene-1-carboxylate, glucoheptonate, 3-phenylpropionate, trimethylacetate, tert-butylacetate, lauryl sulfate, gluconate, benzoate, glutamate, hydroxynaphthoate, salicylate, stearate, cyclohexylsulfamate, quinate, muconate and the like

In certain embodiments, m is a whole number selected from 2-10, 2-8, 2-6, 2-4, or 2-3.

In certain embodiments, R¹ for each occurrence is independently hydrogen or alkyl; or two instances of R¹ taken together with the carbon or carbons to which they are attached form a 3-6, 4-6, or 5-6 membered cycloalkyl. In certain embodiments, R¹ for each occurrence is independently hydrogen, C₁-C₆ alkyl, C₁-C₄ alkyl, C₁-C₂ alkyl, or methyl. In certain embodiments, R¹ is hydrogen.

In certain embodiments, R³ for each occurrence is independently hydrogen, alkyl, or cycloalkyl; or two instances of R³ taken together with the nitrogen to which they are attached form a 3-7, 3-6, 4-6, or 5-6 membered heterocycloalkyl. In certain embodiments, R³ for each occurrence is independently hydrogen, C₁-C₆ alkyl, C₁-C₄ alkyl, C₁-C₂ alkyl, or methyl.

In certain embodiments, the at least one catonizable monomer is represented by the Formula 1:

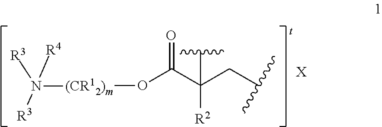

wherein

X is an anion or absent;

t is +1 or 0;

m is a whole number selected from 2-4;

R¹ for each occurrence is hydrogen or alkyl;

R² is hydrogen or methyl;

R³ for each occurrence is independently hydrogen or alkyl; or two instances of R³ taken together with the nitrogen to which they are attached form a 3-6 membered heterocycloalkyl; and R⁴ is a lone pair or hydrogen, wherein if R⁴ is a lone pair then X is absent and t is 0.

In certain embodiments, the at least one catonizable monomer is represented by the moiety of Formula 1, wherein X is an anion or absent; t is +1 or 0; m is 2-4; R¹ is hydrogen; R² is hydrogen or methyl, R³ for each occurrence is independently hydrogen, C₁-C₆ alkyl, C₁-C₄ alkyl, C₁-C₂ alkyl, or methyl; and R⁴ is a lone pair or hydrogen.

In certain embodiments, the at least one catonizable monomer is selected from the group consisting of 2-(dimethylammonium)ethyl methacrylate salt, 2-(dimethylammonium)ethyl acrylate salt, 2-diisopropylammoniumethyl methacrylate salt, and 2-diisopropylammoniumethyl acrylate salt as depicted below:

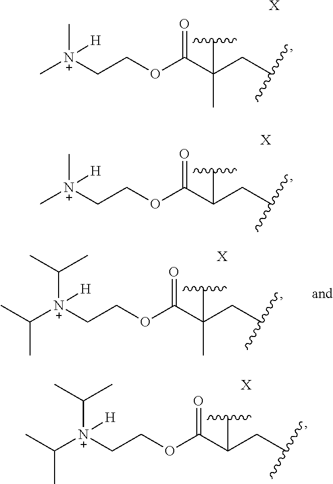

or the conjugate base thereof, wherein X is as described herein.

Depending on the pH of the polymer resin or compositions comprising the same, the at least one catonizable monomer may exist in equilibrium with its cationic form (i.e., equilibrium between the moiety of Formula 1, wherein R⁴ is a lone pair, t is 0, and X is absent; and the cationic form of the moiety of Formula 1, R⁴ is hydrogen, t is +1, and X is an anion). The percentage of the at least one catonizable monomer present in the polymer resin that is in cationic form can be modified by adjusting the pH, e.g., by an acid or a base. Between 0.1%-100% of the moiety of Formula 1 may be in cationic form. In certain embodiments, between 0.1%-99.99%, 5%-99.99%, 5%-95%, 5%-90%, 10%-90%, 20%-90%, 30%-90%, 40%-90%, 40%-80%, 40%-70%, 50%-70%, or 60%-70% of the moiety of Formula 1 is in cationic form.

The at least one catonizable monomer comprises a cationizable group. The term “cationizable group” is understood to mean groups which may be rendered cationic as a function of the pH of the medium. (For example, pH>9 for tertiary amine functional groups). In certain embodiments, cationizable group also include quaternary ammonium groups, such as tetralkyl ammonium groups. Exemplary cationizable groups include, but are not limited to quaternary ammoniums or primary, secondary or tertiary amines, pyrridiniums, imidazoliums, guanidiniums, phosphoniums or sulfoniums.

The polymer resin may comprise 1, 2, 3, 4, or more polarizable monomers. In certain embodiments, the at least one polarizable monomer is represented by the Formula 2:

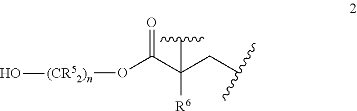

wherein

n is a whole number selected from 2-10;

R⁵ for each occurrence is independently hydrogen, alkyl, cycloalkyl, or aryl; or two instances of R⁵ taken together with the carbon or carbons to which they are attached form a 3-7 membered cycloalkyl; and

R⁶ is hydrogen or methyl.

In certain embodiments, n is a whole number selected from 2-10, 2-8, 2-6, 2-4, or 2-3.

In certain embodiments, the at least one polarizable monomer is represented by the Formula 2:

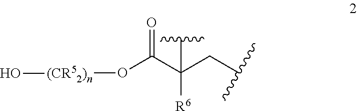

wherein

n is a whole number selected from 2-4;

R⁵ for each occurrence is hydrogen or alkyl; and

R⁶ is hydrogen or methyl.

In certain embodiments, R⁵ for each occurrence is independently hydrogen or alkyl; or two instances of R⁵ taken together with the carbon or carbons to which they are attached form a 3-6, 4-6, or 5-6 membered cycloalkyl. In certain embodiments, R⁵ for each occurrence is independently hydrogen, C₁-C₆ alkyl, C₁-C₄ alkyl, C₁-C₂ alkyl, or methyl. In certain embodiments, R¹ is hydrogen.

The polymer resin may comprise at least one diluent monomer. In certain embodiments, the polymer resin comprises 1, 2, 3, 4, or more diluent monomers. In certain embodiments, the at least one diluent monomer is represented by the Formula 3:

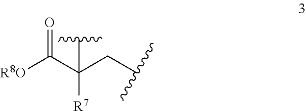

wherein R⁷ is hydrogen or methyl; and

R⁸ is alkyl.

In certain embodiments, R⁸ is C₁-C₁₂ alkyl, C₁-C₁₀ alkyl, C₁-C₈ alkyl, C₁-C₆ alkyl, C₂-C₆ alkyl, C₂-C₅ alkyl, C₃-C₅ alkyl, C₁-C₄ alkyl, C₁-C₃ alkyl, or C₁-C₂ alkyl.

In certain embodiments, the at least one diluent monomer is selected from the group consisting of: 2-hydroxypropyl acrylate, 2-hydroxyethyl methacrylate, 4-hydroxybutyl acrylate, 4-hydroxybutyl methacrylate, 3-phenoxy-2-hydroxypropyl acrylate, 3-phenoxy-2-hydroxypropyl methacrylate, 2-hydroxyethyl acrylate, and 2-hydroxyethyl methacrylate as shown below:

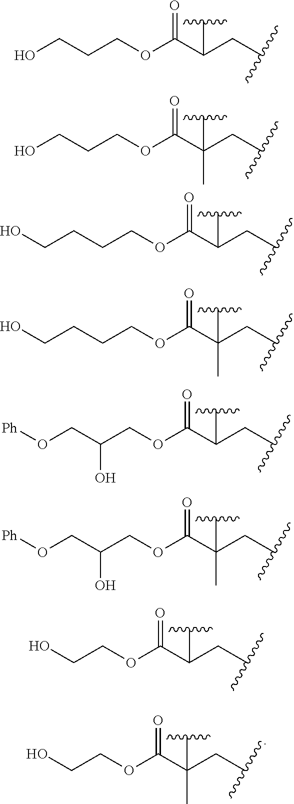

In certain embodiments, the polymer resin comprises a first diluent monomer and a second diluent monomer, wherein the first diluent monomer and the second diluent monomer are each independently represented by the Formula 3. In certain embodiments, the first diluent monomer is represented by the Formula 3, wherein R⁷ is C₁-C₆ alkyl, C₂-C₆ alkyl, C₂-C₅ alkyl, or C₃-C₅ alkyl; and R⁸ is methyl; and the second diluent monomer is represented by the Formula 3, wherein R⁷ is C₁-C₄ alkyl, C₁-C₃ alkyl, or C₁-C₂ alkyl; and R⁸ is hydrogen. In certain embodiments, the at least one diluent monomer comprises butyl acrylate monomer and methyl methacrylate monomer as shown below:

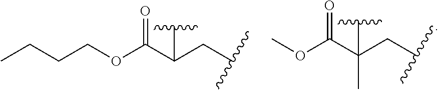

In certain embodiments, the aryl olefin monomer is an optionally substituted C6-C14 aryl olefin monomer; an optionally substituted C6-C10 aryl olefin monomer; or an optionally substituted phenyl olefin monomer. In certain embodiments, the aryl olefin monomer is an optionally substituted phenyl olefin monomer as shown below:

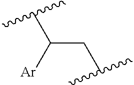

wherein Ar is an optionally substituted C6-C14 aryl; an optionally substituted C6-C10 aryl; or optionally substituted phenyl. In certain embodiments, the aryl olefin monomer is phenyl olefin monomer as shown below:

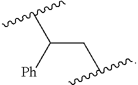 [SMILES: *CC(*)c1ccccc1]

The photoinitiator should be suitable to cause polymerization (i.e., curing) of the anti-tarnish composition after its application to a metal substrate. For most acrylate-based coating formulations, photoinitiators, such as the ketonic photoinitiating and/or phosphine oxide additives, can be used. When used in the anti-tarnish compositions described herein, the photoinitiator is present in an amount sufficient to provide rapid ultraviolet curing.

The polymer resin can optionally crosslinked. In such instances, the polymer resin can be crosslinked using diisocyanates, polyisocyanates biurets of isocyanates and polyisocyanates, isocyanurates of isocyanates and polyisocyanates, and combinations thereof. The isocyanate may include an isocyanate selected from the group of aromatic isocyanates, aliphatic isocyanates, and combinations thereof. Exemplary diisocyanates agent and polyissocyantes, include but at not limited to 2,4-toluene diisocyanate (TDI), 2,6-toluene diisocyanate, trimethyl hexamethylene diisocyanate (TMDI), 4,4′-diphenylmethane diisocyanate (MDI), 4,4′-dicyclohexylmethane diisocyanate (H₁₂MDI), 3,3′-dimethyl-4,4′-biphenyl diisocyanate (TODI), dodecane diisocyanate (C₁₂DI), m-tetramethylene xylylene diisocyanate (TMXDI), 1,4-benzene diisocyanate, trans-cyclohexane-1,4-diisocyanate, 1,5-naphthalene diisocyanate (NDI), 1,6-hexamethylene diisocyanate (HDI), 4,6-xylyene diisocyanate, isophorone diisocyanate (IPDI), and combinations thereof.

The coating thickness adjusting agent can be a non-ionic surfactant. Non-ionic surfactants typically have an uncharged hydrophilic head group. Examples of non-ionic surfactants include surfactants having a poly(alkylene oxide) group, such as a poly(ethylene oxide) group, an alcohol group or another polar group. Suitable non-ionic surfactants may have a hydrophobic group and a reactive hydrogen atom, for example aliphatic alcohols, acids, amides or alkyl phenols with alkylene oxides, especially ethylene oxide either alone or with propylene oxide. Thus, the non-ionic surfactant may be a condensate between an alkylphenol and an alkylene oxide; a polyoxyalkylene sorbitan oleate; or a polyoxyalkylene glycol.

Non-ionic surfactants useful as coating thickness adjusting agents can include alkyl (C₆-C₂₂) phenols-ethylene oxide condensates, the condensation products of aliphatic (C₈-C₁₈) primary or secondary linear or branched alcohols with ethylene oxide. Exemplary Non-ionic surfactants include, but are not limited to, surfactants include polyoxyethylene octyl phenol (such as Triton™ X-100); alkylphenoxypolyethoxy (3) ethanol, polyoxyethylene (20) sorbitan monolaurate (Tween 20), polyoxyethylene (20) sorbitan monopalmitate (Tween 40), polyoxyethylene (20) sorbitan monostearate (Tween 60), polyoxyethylene (20) sorbitan tristearate (Tween 65), polyoxyethylene (20) sorbitan monooleate (Tween 80), polyoxyethylene (20) sorbitan trioleate (Tween 85), polyoxyethylene (20) palmitate (G2079), polyoxyethylene (20) lauryl ether; polyoxyethylene (23), polyoxyethylene (25) hydrogenated castor oil (G1292) and polyoxyethylene (25) oxypropylene monostearate (G2162).

In certain embodiments, the coating thickness adjusting agent is selected from the group consisting of polyoxyethylene octyl phenol (such as Triton X-100) and polyoxyethylene (20) sorbitan monolaurate (Tween 20).

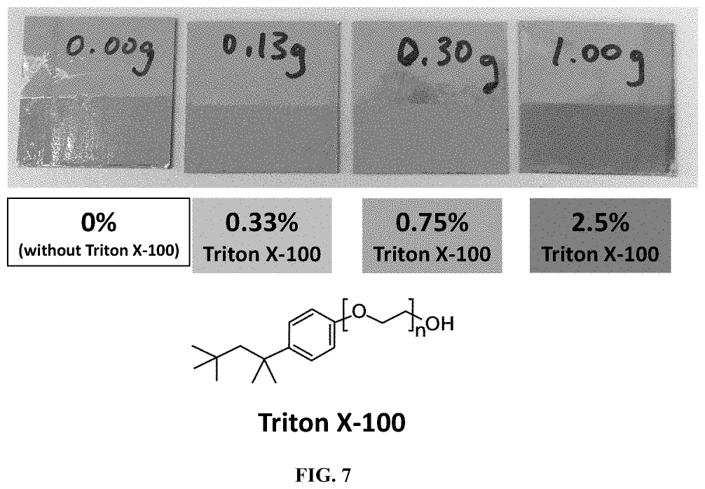

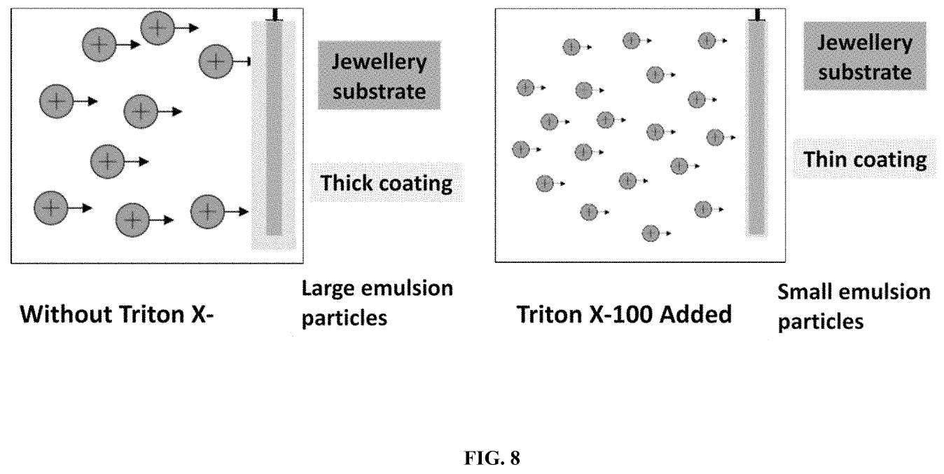

FIGS. 5 and 7 present the results of experiments modifying the amount of Triton X-100 in the anti-tarnish composition. It was observed that when Triton X-100 was present at 0.75% by weight that the resulting applied coating of the anti-tarnish composition was 1 μm. Without wishing to be bound by theory, it is believed that the presence of a non-ionic surfactant can reduce the size of the particles anti-tarnish composition in the electrolyte solution, which results in a thinner layer of the electrochemically deposited layer of the anti-tarnish coating on the metal substrate (as depicted in FIG. 8).

Suitable photoinitiators include, but are not limited to, 1-hydroxycyclohexylphenyl ketone (e.g., Irgacure 184 available from Ciba Specialty Chemical (Hawthorne, N.Y.), bis (2,6-dimethoxybenzoyl)-2,4,4-trimethylpentyl phosphine oxide (e.g., commercial blends Irgacure 1800, 1850, and 1700 available from Ciba Specialty Chemical), 2,2-dimethoxyl-2-phenyl acetophenone (e.g., Irgacure 651, available from Ciba Specialty Chemical), bis(2,4,6-trimethyl benzoyl)phenyl-phosphine oxide (Irgacure 819), (2,4,6-trimethylbenzoyl)diphenyl phosphine oxide (Lucerin TPO, available from BASF (Munich, Germany)), ethoxy (2,4,6-trimethylbenzoyl)phenyl phosphine oxide (Lucerin TPO-L from BASF), and combinations thereof.

In certain embodiments, the dye is an organic and/or inorganic color pigment, such as azo pigments, anazurite, aluminum silicate, aluminum potassium silicate, aluminum paste, anthraquinone pigments, antimony oxide, barium metaborate, barium sulfate, cadmium sulfide, cadmium selenide, calcium carbonate, calcium metaborate, calcium metasilicate, carbon black, chromium oxides, clay, copper oxides, copper oxychloride, dioxazine pigments, feldspar, hansa yellows, iron oxides such as yellow and red iron oxides, isoindoline pigments, kaolinite, lithopone, magnesium silicates, metallic flakes, mica, napthol pigments such as napthol reds, nitroso pigments, nepheline syenite, perinone pigments, perylene pigments, polycyclic pigments, pyrropyrrol pigments, pthalocyanines such as copper pthalocyanine blue and copper pthalocyariine green, quinacridones such as quinacridone violets, quinophthalone pigments, silicates, sulfides, talc, titanium dioxide, ultramarine, zinc chromate, zinc oxide, and zinc phosphate. Additional exemplary organic color pigments include carbon black, and phthalocyanine-, quinacridone-, anthraquinone-, dioxazine-, indigo-, thioindigo-, perinone-, perylene-, isoindoline-, azomethine azo-, indanthrene-, and diketopyrrolopyrrole-type pigments.

In certain embodiments, the dye is a polyacrylic acid based dye comprising at least one organic color pigment and a polymer comprising repeating units selected from acrylic acid, methacrylic acid, ethyl acrylate, isobutyl acrylate, and combinations thereof. In certain embodiments, the polyacrylic acid based dye comprises at least one organic color pigment and a polymer comprising polyacrylic acid repeating units.

In certain embodiments, the particle size of the dye is 50-250 nm.

In certain embodiments, the anti-tarnish composition further comprises a pearlescent, an optical brightener, and the like.

The anti-tarnish compositions described herein can further comprise a solvent selected from the group consisting of water, alcohol, ethers, polyethers, and combinations thereof. In certain embodiments, the anti-tarnish compositions described herein further comprise water, such as deionized and/or distilled water.

In certain embodiments, the polymer resin, the coating thickness adjusting agent, and the photoinitiator are present at 79% to 94% by weight, 4% to 17% by weight, and 2% to 4% by weight respectively with respect to the combined weight of the polymer resin, the coating thickness adjusting agent, and the photoinitiator the anti-tarnish composition.

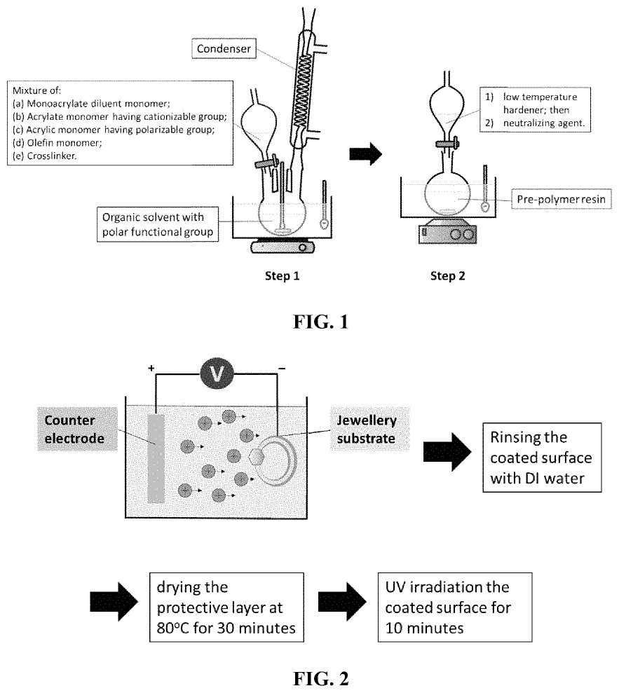

The polymer resin can be prepared using well known polymerization methods known to those of ordinary skill in the art. The polymer resin can be formed by combining the olefinic precursors of the at least one diluent monomer, at least one catonizable monomer, and at least one polarizable monomer in the presence of a radical initiator and inducing the radical initiator to produce radicals thereby initiating the radical chain reaction of the olefinic precursors; optionally crosslinking the resulting polymer; and an organic or inorganic acid thereby forming the polymer resin. FIG. 1 shows an exemplary method and apparatus for conducting the polymerization reaction

Suitable radical initiators include, but are not limited to azo-containing free radical initiators, such as such as azobisisobutyronitrile (AIBN) or 1,1′-azobis(cyclohexanecarbonitrile (ABCN), hydrogen peroxide, hypochlorous acid, and aliphatic and aromatic peroxides or hydroperoxides and peroxy-containing free radical initiators.

The radical polymerization reaction can be conducted in an alcoholic or polyether solvent, such as ethanol, methanol, ethylene glycol butyl ether isopropyl alcohol, and combinations thereof.

The polymer resin can be prepared by polymerizing the olefinic precursors of the monomers at the a concentration of between 25-35 parts by weight of the at least one diluent monomer, 5-15 parts by weight of the at least one catonizable monomer, 5-10 parts by weight of the least one polarizable monomer, and 0.5 to 5 parts by weight of the radical initiator.

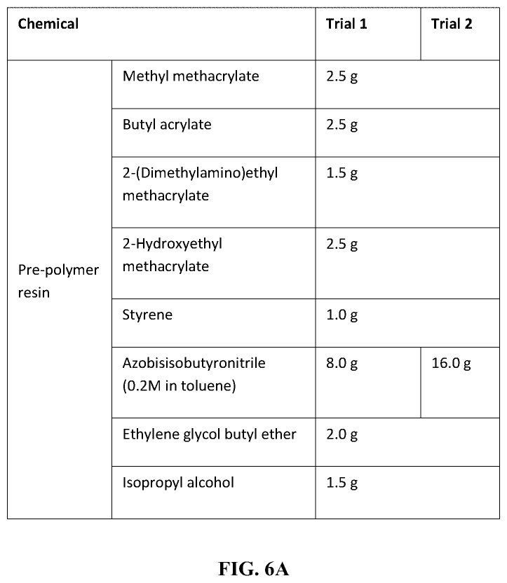

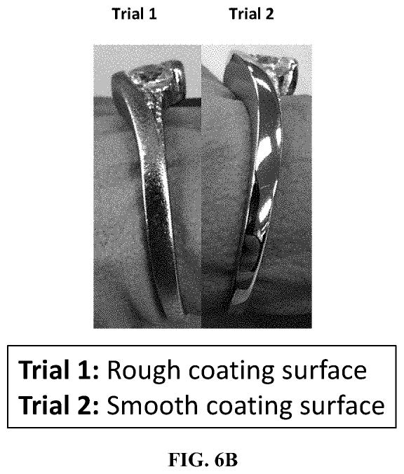

Surprisingly, the amount of the radical initiator can affect the appearance of a metal substrate coated with the anti-tarnish composition described herein. For example, as shown in FIGS. 6A and 6B, when the amount of AIBN is doubled from 8 g to 16 g, the surface of the substrate coated with the anti-tarnish composition becomes smoother.

The radical polymerization reaction can take place between 70 to 110° C.; 70 to 100° C.; 80 to 100° C.; or 85 to 95° C.

The thus formed polymer product can then optionally be crosslinked. The crosslinking agent, such as isophorone diisocyanate and 4,4′-methylenebis(cyclohexyl isocyanate) can be reacted with the polymer in a weight ratio of 1:4.5 to 1:7, respectively.

An acid, such as inorganic or organic acid, can then be reacted with the optionally crosslinked polymer thereby forming the polymer resin. Depending on the portion of portion of the catonizable monomers are cationic form different amounts of acid can be reacted with the polymer to obtain the desired product. In certain embodiments, the acid is reacted with the polymer in a weight ratio between 1:99 to 30:70. The acid can be reacted with the crosslinked polymer in a weight ratio between 3:97 to 6:94, respectively.

The present disclosure also provides a method of applying the anti-tarnish composition provided herein to a metal substrate. In certain embodiments, the method comprises: providing an cathode comprising the metal substrate; an anode; and an electrolyte solution comprising the anti-tarnish composition in contact with the cathode and the anode; and applying an electric current between the cathode and the anode resulting in the electrochemical deposition of the anti-tarnish composition on at least one surface of the metal substrate thereby forming an anti-tarnish coated metal substrate. FIG. 2 depicts a schematic showing an exemplary process for applying the anti-tarnish coating to jewelry.

The metal substrate may be any metal. In certain embodiments, the metal substrate is a metal selected from stainless steel, copper, brass, gold, silver, palladium, platinum, and combinations thereof. In certain embodiments, the substrate is gold, silver, or a gold-copper alloy.

In certain embodiments, the metal substrate is jewelry, such as a necklace, ring, earring, or pendant. In certain embodiments, the jewelry includes a stone, such as a zircon, diamond, emerald, sapphire, ruby, aquamarine, garnet, turquoise, peridot, quartz, amethyst, pearl, jade, or a combination thereof.

The electric current applied in the electrochemical deposition can be up to 30 volts. In certain embodiments, the electric current applied in the electrochemical deposition is between 1 to 30 volts; 1 to 25 volts; 1 to 30 volts; 5 to 30 volts; 10 to 30 volts; 15 to 30 volts; 15 to 25 volts; or 20 to 30 volts.

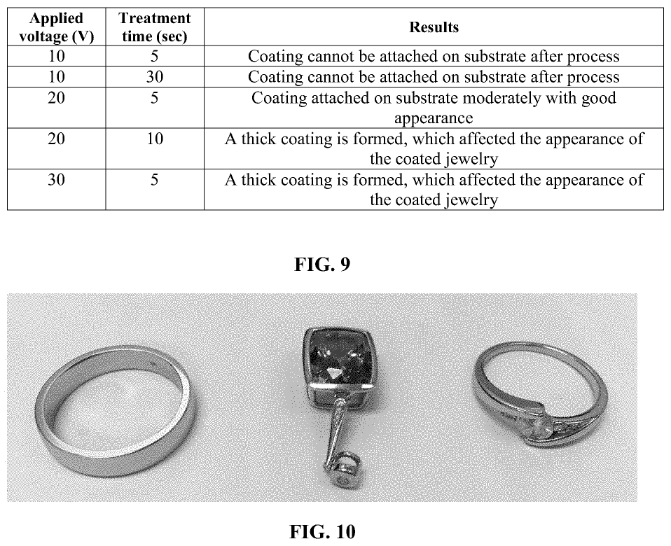

After the electrochemical deposition of the anti-tarnish coating on the metal substrate, the anti-tarnish coated metal substrate can be thermally treated at a temperature between 50-120° C., 50-110° C., 50-100° C., 60-100° C., 60-90° C., or 70-90° C. As demonstrated in FIG. 9, when the applied voltage is 20 volts, the electrochemical deposition of the anti-tarnish coating on the metal substrate is effective with a good visual appearance.

The thermally treated anti-tarnish coated metal substrate can then be treated to irradiation with light. In certain embodiments, the light is visible light, ultraviolet light, or a combination thereof.

In an alternative embodiment, the anti-tarnish coated metal substrate can be directly irradiated with light. In such instances, the light can be visible light, ultraviolet light, or a combination thereof.

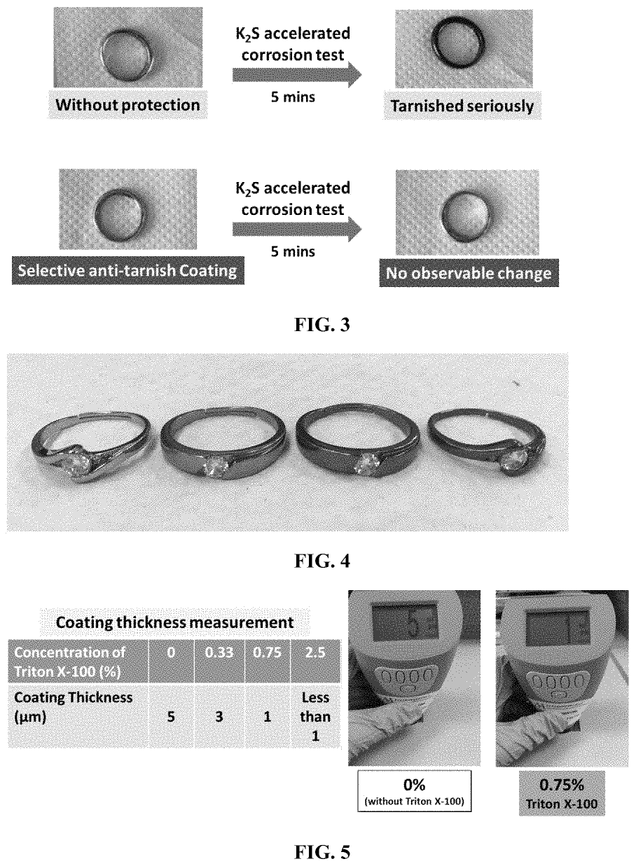

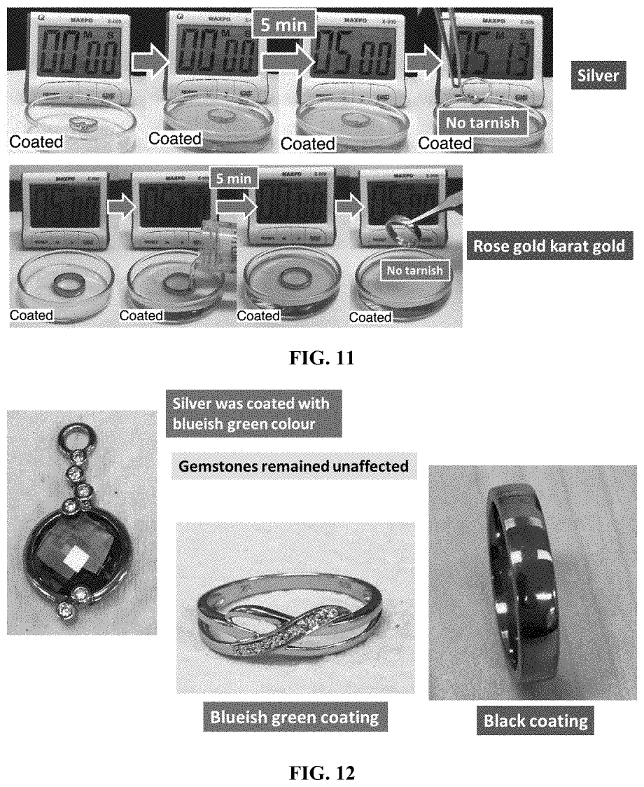

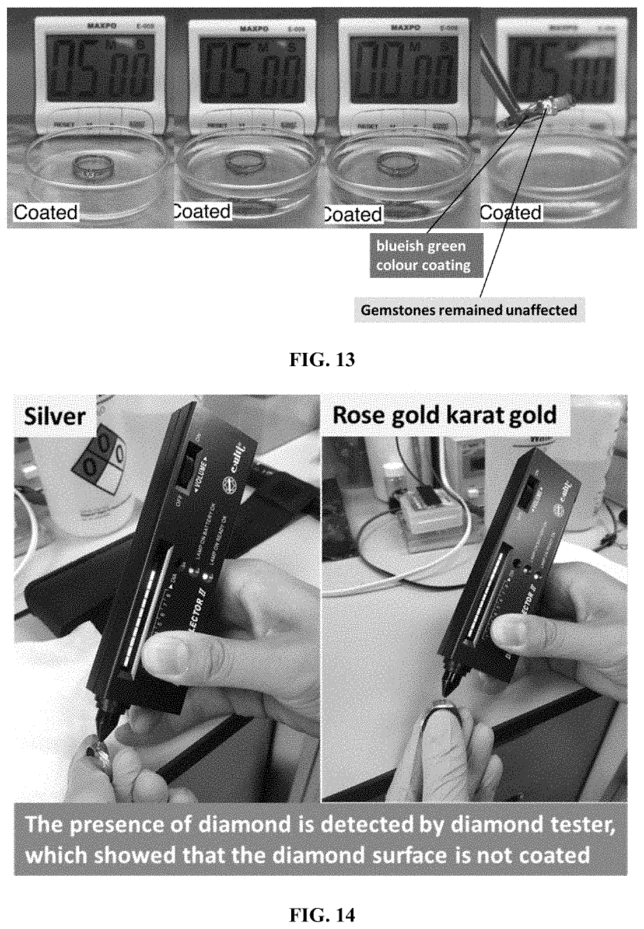

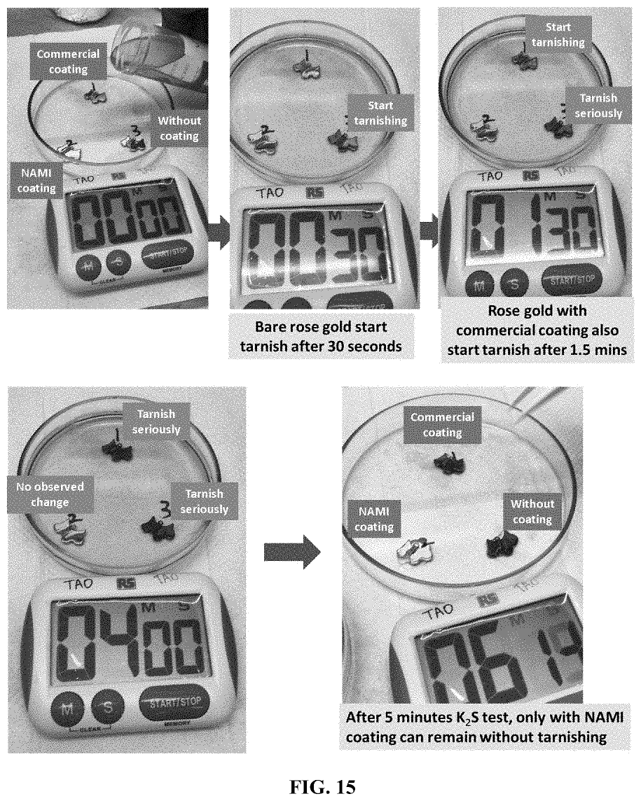

Metal substrates that have been coated using the anti-tarnish compositions described herein exhibit excellent corrosion resistance in accelerated K₂S corrosion experiments (FIGS. 3, 11, 13, and 15). The anti-tarnish compositions described herein can even provide better protection than commercially available anti-tarnish coatings as demonstrated in FIG. 15.

Metal jewelry that has been treated with the anti-tarnish compositions described herein are able retain their original appearance, such as color and surface texture, as demonstrated in FIG. 10.

Advantageously, the anti-tarnish compositions described herein can optionally comprise a dye, which can be used to impart color to a metal substrate. As shown in FIGS. 4 and 12, a blue or blueish green coating can selectively be applied to the metal surface of jewelry containing gemstones and a black coating can be applied to a silver ring.

### EXAMPLES

### Example 1. Preparation of Pre-Polymer Resin

To a round-bottom flask, 2.0 g ethylene glycol butyl ether; and 1.5 g isopropyl alcohol were added. To another breaker: 2.5 g methyl methacrylate; 2.5 g butyl acrylate; 1.5 g 2-(dimethylamino)ethyl methacrylate; 2.5 g 2-hydroxyethyl methacrylate; 1.0 g styrene; 8.0 g azobisisobutyronitrile (0.2M in toluene) were added. The resultant mixture was mixed and added into a dropping funnel. The dropping funnel was connected to a round-bottom flask with a condenser affixed as shown in FIG. 1, Step 1.

The oil bath was heated to 90° C. and the reaction mixture was stirred. The monomer mixture inside dropping funnel was added dropwise to the round bottom flask. When the monomer was fully added into the round bottom flask, the reaction mixture was stirred for 30 minutes longer. 8.0 g azobisisobutyronitrile (0.2M in toluene) was added into the round bottom flask and allowed to stir for 30 minutes. The reaction mixture was cooled down to room temperature yielding approximately 30 g of pre-polymer resin.

### Example 2. Mixing the Pre-Polymer Resin with Acid and Hardener to Form the Polymer Resin

30 g of the pre-polymer resin was added into a round bottom flask and heated to 70° C. with stirring for 10 min. 2.5 g of isophorone diisocyanate was added into the round bottom flask and the reaction mixture was allowed to stir for 30 minutes. 0.9 g lactic acid was added into the round bottom flask and the resulting mixture was allowed to stir for an additional 20 minutes. The reaction mixture was then cooled down to room temperature to obtain the polymer resin.

### Example 3. Preparation of Anti-Tarnish Paint

To a beaker, 5.0 g polymer resin; 0.14 g 2,4,6-trimethylbenzoyl diphenyl phosphine; 0.5 g Triton X 100; 0.08 g of an acrylic based color pigment (pigment particle size 50-250 nm); and 35 mL DI water were added. The mixture was subjected to ultrasound at room temperature for 10 minutes for better dispersion of mixture. Then the anti-tarnish composition could then be used.

### Example 4. Procedure of Applying Anti-Tarnish Paint on Jewelry Substrates

The jewelry substrate was connected to the cathode and stainless steel plate (counter electrode) was connected to the anode. Both jewelry substrate and counter electrode were immersed into the anti-tarnish composition of Example 3. The electric current was switched on under 20 volts for 5 seconds, the anti-tarnish composition then coated on the metal part of jewelry substrate. The electric current was then switched off and the jewelry substrate was removed from anti-tarnish composition. The coated jewelry surface was rinsed with DI water. The coated jewelry was dried at 80° C. for 30 minutes and irradiated with UV light (365 nm UV lamp 50 W power) on the coated surface for 10 minutes.

What is claimed is:

1. An anti-tarnish composition comprising:
a polymer resin comprising: at least one diluent monomer selected from the group consisting of an alkyl acrylate and an alkyl methacrylate; at least one catonizable monomer selected from the group consisting of a catonizable acrylate monomer and a catonizable methacrylate monomer, wherein at least a portion of the at least one catonizable monomer is in cationic form; at least one polarizable monomer selected from the group consisting of a hydroxyl containing acrylate monomer and a hydroxyl containing methacrylate monomer; and an aryl olefin monomer, wherein the polymer resin is optionally crosslinked;
a photoinitiator;
a coating thickness adjusting agent;
and optionally a dye.

2. The anti-tarnish composition of claim 1, wherein the at least one catonizable monomer comprises a cationizable group selected from the group consisting of a primary ammonium, secondary ammonium, tertiary ammonium, a quaternary ammonium and a pyrridinium.

3. The anti-tarnish composition of claim 1, wherein the at least one catonizable monomer is represented by the Formula 1: 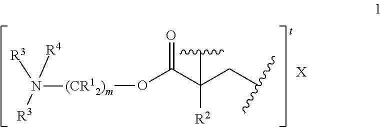
wherein
X is an anion or is absent;
t is +1 or 0;
m is a whole number selected from 2-10;
R¹ for each occurrence is independently hydrogen, alkyl, cycloalkyl, or aryl; or two instances of R¹ taken together with the carbon or carbons to which they are attached form a 3-7 membered cycloalkyl;
R² is hydrogen or methyl;
R³ for each occurrence is independently hydrogen, alkyl, alkenyl, alkynyl, cycloalkyl, aryl, aralkyl, heteroaryl, or heteroaralkyl; or two instances of R³ taken together with the nitrogen to which they are attached form a 3-7 membered heterocycloalkyl or 5 membered heteroaryl; or one instance of R¹ and one instance of R³ taken together with the atoms to which they are attached form a 3-7 membered heterocycloalkyl; and
R⁴ is a lone pair, hydrogen, or alkyl, wherein if R⁴ is a lone pair then X is absent and t is 0.

4. The anti-tarnish composition of claim 3, wherein X is Cl⁻, Br⁻, I⁻, NO₃⁻, PO₄³⁻, HPO₄²⁻, H₂PO₄⁻, SO₄²⁻, HSO₄⁻, CH₃CO₂⁻, HCO₂⁻, lactate, tartrate, citrate, propionate, oxalate, malate, succinate, benzoate, methylsulfonate, or phenylsulfonate.

5. The anti-tarnish composition of claim 1, wherein the at least one cationizable monomer is selected from the group consisting of 2-(dimethylamino)ethyl methacrylate, 2-(dimethylamino)ethyl acrylate, a 2-diisopropylaminoethyl methacrylate, and 2-diisopropylaminoethyl acrylate.

6. The anti-tarnish composition of claim 1, wherein the at least one polarizable monomer is represented by the Formula 2: 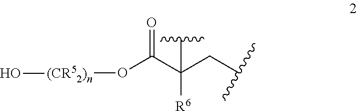
wherein
n is a whole number selected from 2-10;
R⁵ for each occurrence is independently hydrogen, alkyl, cycloalkyl, or aryl; or two instances of R⁵ taken together with the carbon or carbons to which they are attached form a 3-7 membered cycloalkyl; and
R⁶ is hydrogen or methyl.

7. The anti-tarnish composition of claim 1, wherein the at least one polarizable monomer is selected from the group consisting of 2-hydroxypropyl acrylate, 2-hydroxyethyl methacrylate, 4-hydroxybutyl acrylate, 4-hydroxybutyl methacrylate, 3-phenoxy-2-hydroxypropyl acrylate, 3-phenoxy-2-hydroxypropyl methacrylate, 2-hydroxyethyl acrylate, and 2-hydroxyethyl methacrylate.

8. The anti-tarnish composition of claim 1, wherein the aryl olefin monomer is an optionally substituted phenylethylene monomer.

9. The anti-tarnish composition of claim 1, wherein the polymer resin is crosslinked with a diisocyanate or a polyisocyanate.

10. The anti-tarnish composition of claim 1, wherein the polymer resin is crosslinked with isophorone diisocyanate or 4,4′-methylenebis(cyclohexyl isocyanate).

11. The anti-tarnish composition of claim 1, wherein the photoinitiator is an acylphosphine oxide.

12. The anti-tarnish composition of claim 1, wherein the photoinitiator is bis(2,4,6-trimethyl benzoyl)phenyl phosphine oxide (BAPO) or 2,4,6-trimethylbenzoyl diphenyl phosphine (TPO).

13. The anti-tarnish composition of claim 1, wherein the coating thickness adjusting agent is a non-ionic surfactant.

14. The anti-tarnish composition of claim 1, wherein the coating thickness adjusting agent is t-octylphenoxypolyethoxyethanol or polyethylene glycol sorbitan monolaurate.

15. The anti-tarnish composition of claim 1, wherein the dye is selected from the group consisting of polyacrylic acid based dyes.

16. The anti-tarnish composition of claim 1, wherein the dye has an average particle size between 50 to 250 nm.

17. The anti-tarnish composition of claim 1, wherein the anti-tarnish composition comprises: a polymer resin comprising: at least one diluent monomer selected from the group consisting of C₁-C₈ alkyl acrylate and C₁-C₈ alkyl methacrylate; at least one catonizable monomer represented by the Formula 1: 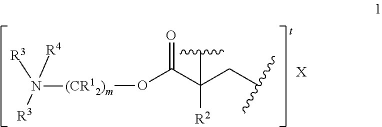
wherein
X is an anion or absent;
t is +1 or 0;
m is a whole number selected from 2-4;
R¹ for each occurrence is hydrogen or alkyl;
R² is hydrogen or methyl;
R³ for each occurrence is independently hydrogen or alkyl; or two instances of R³ taken together with the nitrogen to which they are attached form a 3-6 membered heterocycloalkyl; and
R⁴ is a lone pair or hydrogen, wherein if R⁴ is a lone pair then X is absent and t is 0;
at least one polarizable monomer represented by the Formula 2: 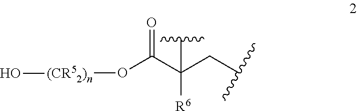
wherein
n is a whole number selected from 2-4;
R⁵ for each occurrence is hydrogen or alkyl; and
R⁶ is hydrogen or methyl;
an optionally substituted phenylethylene monomer; and
the polymer resin is crosslinked with a diisocyanate or a polyisocyanate;
an acylphosphine oxide;
a non-ionic surfactant; and
optionally a dye.

18. The anti-tarnish composition of claim 17, wherein the polymer resin, the non-ionic surfactant, and the acylphosphine oxide are present at 79% to 94% by weight, 4% to 17% by weight, and 2% to 4% by weight respectively with respect to the combined weight of the polymer resin, the non-ionic surfactant, and the acylphosphine oxide.

19. The anti-tarnish composition of claim 18 further comprising up to 6% by weight of the dye.

20. The anti-tarnish composition of claim 1, wherein the anti-tarnish composition comprises:
a polymer resin comprising: butyl acrylate monomer, methyl methacrylate monomer; 2-(dimethylamino)ethyl methacrylate monomer, wherein at least a portion of the 2-(dimethylamino)ethyl methacrylate monomer exists as a conjugate lactate salt; and 2-hydroxyethyl methacrylate monomer, wherein the polymer resin is crosslinked with isophorone diisocyanate; t-octylphenoxypolyethoxyethanol;
TPO; and
optionally a dye,
wherein the polymer resin, t-octylphenoxypolyethoxyethanol, TPO, and the dye are present relative to their combined weight at 79% to 94% by weight, 4% to 17% by weight, 2% to 4% by weigh, and 0% to 6% by weight, respectively.

21. A method for applying the anti-tarnish composition of claim 1 to a metal substrate, the method comprising:
providing an cathode comprising the metal substrate;
an anode; and
an electrolyte solution comprising the anti-tarnish composition in contact with the cathode and the anode; and
applying an electric current between the cathode and the anode resulting in the electrochemical deposition of the anti-tarnish composition on at least one surface of the metal substrate thereby forming an anti-tarnish coated metal substrate.

22. The method of claim 21, wherein the electric current is applied at a voltage below 30 volts.

23. The method of claim 21 further comprising the step of heating the anti-tarnish coated metal substrate at a temperature between 50-120° C. thereby forming a thermally treated anti-tarnish coated metal substrate.

24. The method of claim 21 further comprising the step of irradiating the anti-tarnish coated metal substrate with UV light.

25. The method of claim 23 further comprising the step of irradiating the thermally treated anti-tarnish coated metal substrate with UV light.
